(19) United States
(12) Patent Application Publication
(10) Pub. No.: US 2007/0250397 A1
(43) Pub. Date: Oct. 25, 2007

(54) METHOD OF SELLING PRODUCTS ONLINE

(76) Inventor: Husein Abusalih, Richardson, TX (US)

Correspondence Address: Michael A. O'Neil;Michael A. O'Neil, P.C., Suite 820, 5949 Sherry Lane, Dallas, TX, 75225, US

(21) Appl. No.: 11/689,831

(22) Filed: Mar. 22, 2007

Related U.S. Application Data
(60) Provisional application No. 60/745,481, filed on Apr. 24, 2006.

(51) Int. Cl. G06Q 30/00

(52) U.S. Cl. 705/26

(57) ABSTRACT

A method of selling products online comprising generating a plurality of electronic tickets for sale wherein each ticket has a price that is an equal, fractional share of the selling price of the product, a number is assigned to each ticket and associated with the buyer thereof, and at a predetermined time a ticket number is randomly selected and the buyer of the selected ticket is awarded the product.

### CROSS-REFERENCE TO RELATED APPLICATION

This application claims priority based on provisional patent application Ser. No. 60/745,481 filed Apr. 24, 2006, the entire content of which is incorporated herein by reference.

### TECHNICAL FIELD

This invention relates to a method of selling products online wherein a selling price for a product is determined, the selling price is divided by a predetermined number to determine a fractional price, chances to acquire the product are sold at the fractional price to buyers, and one of the buyers is randomly selected to acquire the product.

### BACKGROUND AND SUMMARY OF THE INVENTION

Selling products online is well known in the art. Particularly prominent are online auctions where potential buyers bid on products and online retailers that simply sell products online at prices that are oftentimes reduced from standard retail prices.

A drawback of online auctions is the great amount of uncertainty about the eventual selling price that is inherent in the process. Products may sell for more or less than a seller expects or desires. Though online auctions are typically available for use by sellers that are not affiliated with established businesses, online retailers typically are not. Instead, online retailers are typically owned and operated by large companies and sell products that the companies also sell in their stores.

The present invention comprises a method of selling products online that is wholly different from the prior art. In accordance with its broader elements, the invention incorporates the structure of a raffle, whereby persons interested in acquiring a product buy tickets and a ticket is randomly chosen, the owner of the ticket being the winner of the raffled product.

A product is sold online by selling tickets or chances at a fractional cost of the selling price of the product to those interested in acquiring the product. The selling price is determined by the seller, and includes a fee paid by the seller to the proprietor of the online website for the right to sell the product thereon. The number of tickets generated and the fractional cost of each ticket is variable by the proprietor of the website.

In accordance with the invention software is provided that assigns numbers to the tickets or chances, receives and stores information on the buyers of the tickets and associates the buyer information with the corresponding ticket numbers. At a predetermined time, typically when all the tickets have been sold, a ticket number is randomly selected using software known in the art and the buyer of the ticket corresponding to the selected number acquires the product.

If all of the tickets are not sold within the predetermined time the seller is given the option of either having a ticket number randomly selected, and thus having the product sold for less than the selling price, or paying the proprietor a fee to withdraw the offer to sell the product. If the seller chooses the latter, the proprietor refunds the amounts paid by the ticket buyers.

Thus, the invention allows sellers to sell products, whether goods or services, online at prices higher than they may otherwise be able to through online auctions. Further, the invention allows buyers to potentially acquire products at a fraction of the usual cost while requiring the buyers to risk a minimal amount for the chance to acquire desired products.

### BRIEF DESCRIPTION OF THE DRAWINGS

A more complete understanding of the present invention may be had by reference to the following Detailed Description when taken in connection with the accompanying Drawings, wherein:

FIG. 1 is a flow chart showing the steps of an embodiment of the invention.

### DETAILED DESCRIPTION

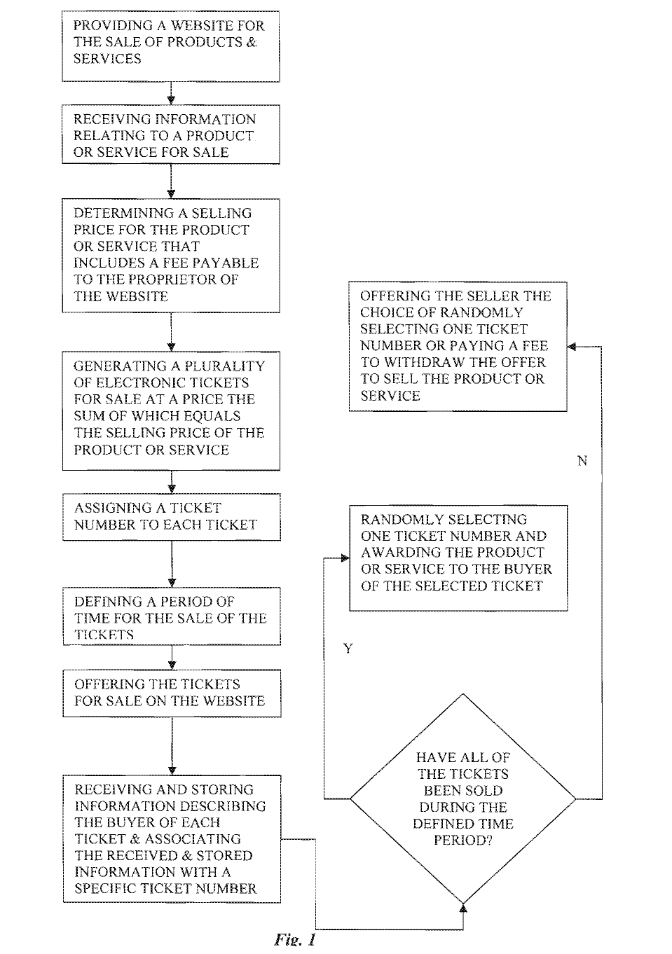

Referring now to FIG. 1, there is shown a flowchart illustrating the steps of one embodiment of the method of the invention. The first step of this embodiment is providing an online website for the sale of products. This is done by a website proprietor, the knowledge of how to provide a website being well known in the art.

In the second step the proprietor receives information about a product that a seller desires to sell. This can be done via submission of the information to the proprietor via the website such as a description of the product, the desired selling price, and an identification of the seller. The third step entails determining a selling price for the product that includes the sellers desired selling price plus a fee for the proprietor.

In the next step software generates a plurality of electronic tickets for sale wherein each ticket has a price that is an equal, fractional part of the predetermined selling price. Thus, the summation of the prices of the individual tickets equals the selling price of the product. A ticket number is assigned to each ticket by the software.

A period of time during which the tickets will be offered for sale is determined, and the tickets are offered for sale on the website. Buyers purchase tickets by accessing the website. Information describing each buyer is received, stored, and associated with the ticket number of the ticket purchased. A buyer may purchase one or all of the tickets offered.

If all of the tickets offered for sale are sold within the predetermined time period, software that is known in the art randomly selects one of the ticket numbers, and the buyer of the ticket associated with the selected ticket number obtains the product.

If all of the tickets offered for sale are not sold within the predetermined time period, the seller is offered a choice of having a ticket number randomly selected or withdrawing the offer to sell the product on the website. If the buyer chooses the former, the buyer would by definition receive less for the product that the predetermined selling price. If the buyer chooses the latter, the buyer will be required to pay, a fee to the website proprietor for having the product withdrawn, and the proprietor refunds the price of the tickets to each buyer.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A method of selling goods and services online comprising the steps of:
providing and maintaining a website for the sale of goods and services;
receiving from a seller information on a specific good or service to be sold;
determining a selling price for the specific good or service, the selling price including a fee for provision and maintenance of the website;
generating a predetermined number of electronic tickets;
dividing the selling price by the predetermined number of electronic tickets and thereby determining the selling price of each electronic ticket;
assigning a ticket number to each electronic ticket;
establishing a period of time during which the predetermined number of electronic tickets to be sold;
offering each electronic ticket comprising the predetermined number thereof for sale on the website;
receiving and storing information regarding the buyer of each electronic ticket;
associating the received and stored buyer information with the ticket number corresponding to the electronic ticket purchased by the buyer;
randomly selecting one of the electronic tickets from among all of the electronic tickets comprising the predetermined number of electronic tickets; and
awarding the specific good or service to be sold to the buyer of the selected electronic ticket.

2. The method of selling goods and services online according to claim 1 including the additional steps of:
if all of the electronic tickets are sold during the established period of time expires, awarding the specific good or service to the buyer of the selected electronic ticket; and
if all of the electronic tickets are not sold during the established period of time, offering the seller a choice of randomly selecting one of the electronic tickets from among all of the electronic tickets that have been sold and awarding the specific good or service to the buyer of the selected ticket, or paying a fee for withdrawing offer of sale of the specific good or service.
